(19) United States
(12) Patent Application Publication
(10) Pub. No.: US 2026/0261924 A1
(43) Pub. Date: Sep. 3, 2026

(54) MULTIPLE TA AND APPLICATION OF TAS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/713,571

(22) PCT Filed: Jan. 28, 2022
(86) PCT No.: PCT/CN2022/074543

§ 371 Date: May 24, 2024

(51) Int. Cl. H04W 36/00; H04B 7/06; H04W 72/1263

(52) U.S. Cl. CPC H04W 36/0072; H04B 7/0626; H04W 72/1263

(57) ABSTRACT

Methods, apparatuses, and computer-readable storage medium for wireless communication with timing advance (TA) are provided. An example method at a user equipment (UE) may include receiving, from a network entity, a first timing advance (TA) associated with a first transmission reception point (TRP) associated with the network entity in first downlink control information (DCI). The example method may further include receiving, from the network entity, a second TA associated with a second TRP associated with the network entity in second DCI, the first TA and the second TA being associated with different sets of uplink (UL) channels based on an association configuration. The example method may further include communicating with the network entity based on the first TA and the second TA.

### TECHNICAL FIELD

The present disclosure relates generally to communication systems, and more particularly, to wireless communication systems with timing advance (TA) and transmission reception point (TRP).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include a memory and at least one processor coupled to the memory. The memory and the at least one processor coupled to the memory may be configured to receive, from a network entity, a first TA associated with a first TRP associated with the network entity. The memory and the at least one processor coupled to the memory may be further configured to receive, from the network entity, a second TA associated with a second TRP associated with the network entity, the first TA and the second TA being associated with different sets of uplink (UL) channels based on an association configuration. The memory and the at least one processor coupled to the memory may be further configured to communicate with the network entity based on the first TA and the second TA.

In another aspect of the disclosure, a method, a computer-readable medium, and an apparatus at a UE are provided. The apparatus may include a memory and at least one processor coupled to the memory. The memory and the at least one processor coupled to the memory may be configured to receive, from a network entity, a first TA associated with a first TRP associated with the network entity. The memory and the at least one processor coupled to the memory may be further configured to receive, from the network entity, a second TA associated with a second TRP associated with the network entity, the first TA and the second TA being associated with a single component carrier (CC). The memory and the at least one processor coupled to the memory may be further configured to communicate with the network entity based on the first TA and the single CC or based on the second TA and the single CC.

In another aspect of the disclosure, a method, a computer-readable medium, and an apparatus at a network entity are provided. The apparatus may include a memory and at least one processor coupled to the memory. The memory and the at least one processor coupled to the memory may be configured to transmit, to a UE, a first TA associated with a first TRP associated with the network entity. The memory and the at least one processor coupled to the memory may be further configured to transmit, to the UE, a second TA associated with a second TRP associated with the network entity, the first TA and the second TA being associated with different sets of UL channels based on an association configuration. The memory and the at least one processor coupled to the memory may be further configured to communicate with the UE based on the first TA and the second TA.

In another aspect of the disclosure, a method, a computer-readable medium, and an apparatus at a network entity are provided. The apparatus may include a memory and at least one processor coupled to the memory. The memory and the at least one processor coupled to the memory may be configured to transmit, to a UE, a first TA associated with a first TRP associated with the network entity. The memory and the at least one processor coupled to the memory may be further configured to transmit, to the UE, a second TA associated with a second TRP associated with the network entity, the first TA and the second TA being associated with a single CC. The memory and the at least one processor coupled to the memory may be further configured to communicate with the UE based on the first TA and the single CC or based on the second TA and the single CC.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is a diagram illustrating example communications between a UE and two TRPs.

FIG. 4B is a diagram illustrating example TA.

FIGS. 5A-5B are diagrams illustrating single downlink (DL) timing or separate DL timing.

FIGS. 6A-C are diagrams illustrating different bandwidth parts (BWPs) configured with single downlink control information (DCI) (sDCI) or multi-DCI (mDCI) operations or single TRP (sTRP) or multi-TRP (mTRP) operations.

FIG. 7 is a diagram illustrating example communications between a network entity and a UE.

FIG. 8 is a diagram illustrating example associations of timing advance group (TAG) with unified transmission configuration indicator (TCI).

FIG. 9 is a diagram illustrating wireless communications with supporting a default TA to a BWP or CC where UL involves a single TRP.

FIG. 10 is a diagram illustrating wireless communications with indicating whether a BWP or CC to be applied with two TAs or a single selected TA.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

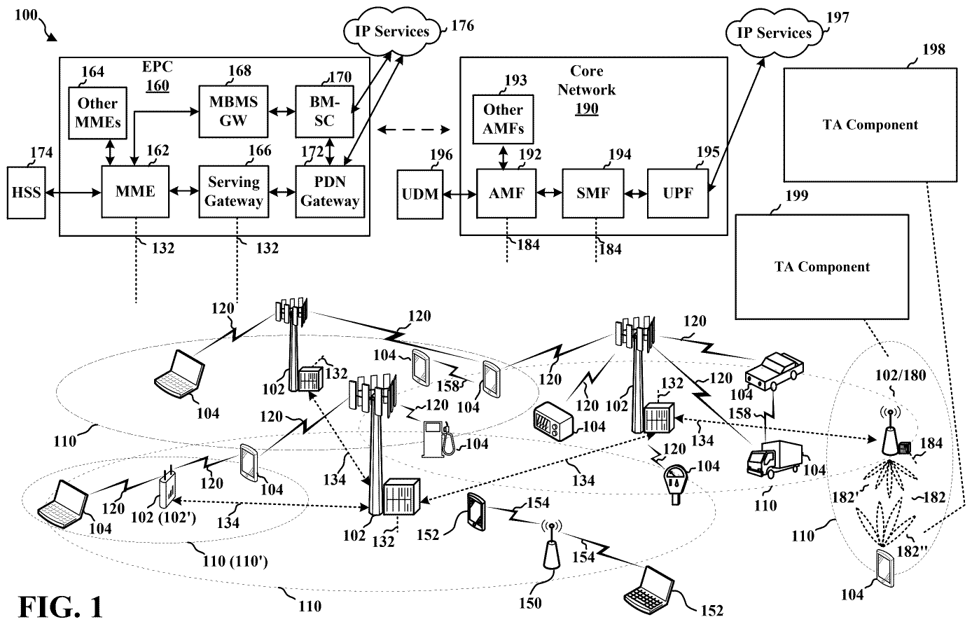

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a TA component 198. In some aspects, the TA component 198 may be configured to receive, from a network entity, a first TA associated with a first TRP associated with the network entity. In some aspects, the TA component 198 may be further configured to receive, from the network entity, a second TA associated with a second TRP associated with the network entity, the first TA and the second TA being associated with different sets of UL channels based on an association configuration. The first TRP and the second TRP may be associated with the first DCI and the second DCI in the network entity. In some aspects, the TA component 198 may be further configured to communicate with the network entity based on the first TA and the second TA.

In some aspects, the TA component 198 may be configured to receive, from a network entity, a first TA associated with a first TRP associated with the network entity. In some aspects, the TA component 198 may be further configured to receive, from the network entity, a second TA associated with a second TRP associated with the network entity, the first TA and the second TA being associated with a single CC. The first TRP and the second TRP may be associated with the first DCI and the second DCI in the network entity. In some aspects, the TA component 198 may be further configured to communicate with the network entity based on the first TA and the single CC or based on the second TA and the single CC.

In certain aspects, the base station 180 may include a TA component 199. In some aspects, the TA component 199 may be configured to transmit, to a UE, a first TA associated with a first TRP associated with the network entity. In some aspects, the TA component 199 may be further configured to transmit, to the UE, a second TA associated with a second TRP associated with the network entity, the first TA and the second TA being associated with different sets of UL channels based on an association configuration. The first TRP and the second TRP may be associated with the first DCI and the second DCI in the network entity. In some aspects, the TA component 199 may be further configured to communicate with the UE based on the first TA and the second TA.

In some aspects, the TA component 199 may be configured to transmit, to a UE, a first TA associated with a first TRP associated with the network entity. In some aspects, the TA component 199 may be further configured to transmit, to the UE, a second TA associated with a second TRP associated with the network entity, the first TA and the second TA being associated with a single CC. The first TRP and the second TRP may be associated with the first DCI and the second DCI in the network entity. In some aspects, the TA component 199 may be further configured to communicate with the UE based on the first TA and the single CC or based on the second TA and the single CC.

Although the following description may be focused on 5G NR, the concepts described herein may be applicable to other similar areas, such as LTE, LTE-A, CDMA, GSM, and other wireless technologies.

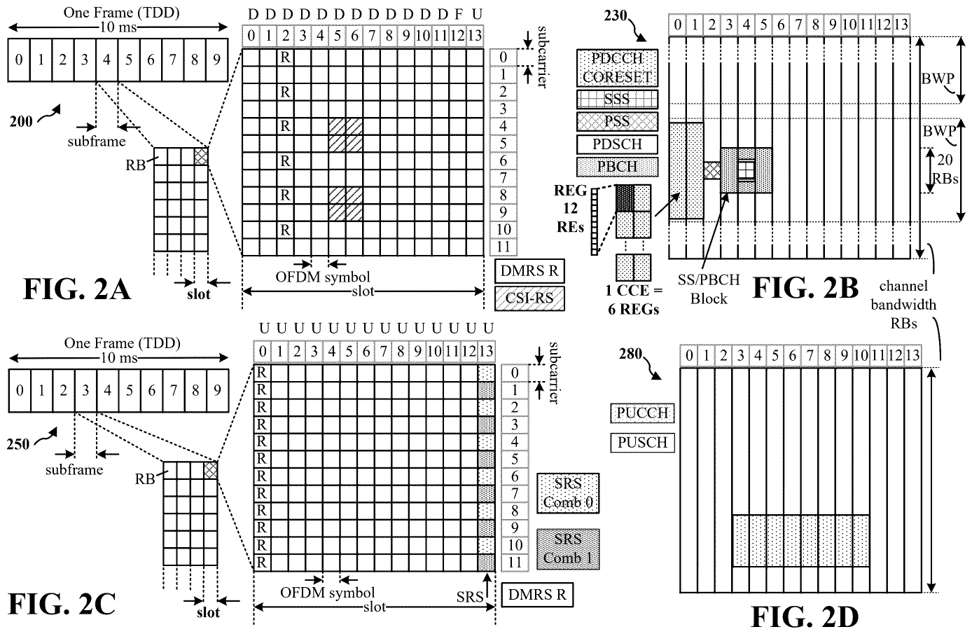

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

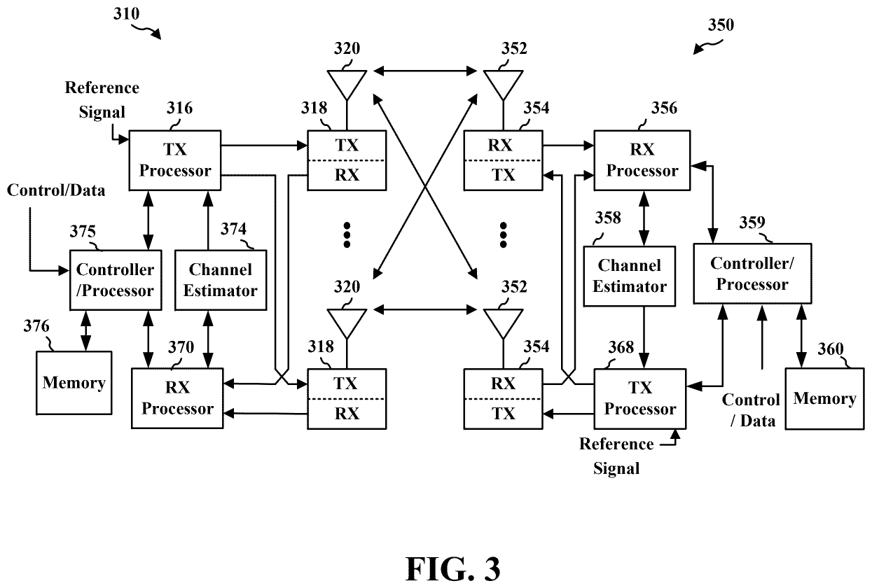

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with TA component 198 of FIG. 1.

At least one of the TX processor 316, the RX processor 370, and the controller/processor 375 may be configured to perform aspects in connection with TA component 199 of FIG. 1.

A wireless device supporting a network entity in a wireless communication system, such as a base station, may include mTRP configurations. By way of example, each TRP may include different RF modules having a shared hardware and/or software controller. Each TRP may have separate RF and digital processing. Each TRP may also perform separate baseband processing. In some aspects, each TRP may include a different antenna panel or a different set of antenna elements of a wireless device. The TRPs of the wireless device may be physically separated. For example, different TRPs may be located at different locations while sharing a same processing (e.g., radio unit (RU), central unit (CU) or distributed unit (DU) processing). Each of the TRPs may experience a channel differently (e.g., experience a different channel quality) due to the difference physical location, the distance between the TRPs, different line-of-sight (LOS) characteristics (e.g., a LOS channel in comparison to a non-LOS (NLOS) channel), blocking/obstructions, interference from other transmissions, among other reasons.

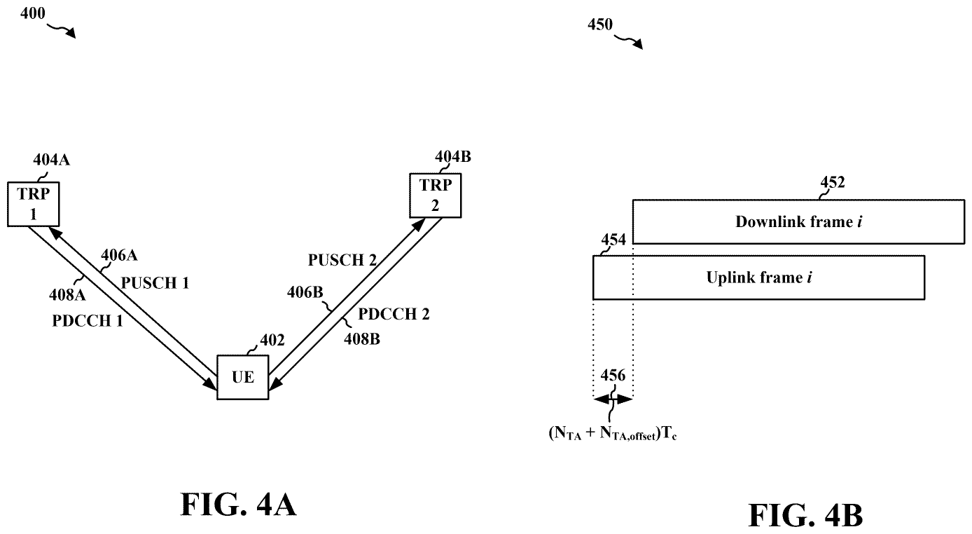

FIG. 4A is a diagram 400 illustrating example communications between a UE and two TRPs. As illustrated in FIG. 4A, a UE 402 may be simultaneously connected to a first TRP 404A and a second TRP 404B. In some aspects, the UE 402 may receive a first PDCCH 408A from the first TRP 404A. The UE 402 may also transmit a first PUSCH 406A to the first TRP 404A. In some aspects, the UE 402 may receive a second PDCCH 408B from the second TRP 404B. The UE 402 may also transmit a second PUSCH 406B to the second TRP 404B.

A UE may transmit an UL signal to a base station or a TRP. The UL signal may take a length of time to reach the destination base station or the TRP because the signal may travel from the UE to the destination base station or TRP for a length of time. Therefore, to meet a defined arrival time (e.g., defined based on slots or other units) in a wireless communication system, a UE in the wireless communication system may transmit UL signals based on a TA. As one example, the UE may transmit an UL signal a length of time before the defined arrival time based on a TA, which may be based on a distance between the UE and the TRP. FIG. 4B is a diagram 450 illustrating example TA. As illustrated in FIG. 4B, a DL frame of frame number i 452 and an associated UL frame of frame number i 454 may be transmitted on a RF carrier. The UL frame of frame number i 454 may start in advance of the DL frame of frame number i 452 by a TA 456 that may be equal to (N_{TA}+N_{TA,offset})T_{c}. The parameter T_{c} may represent a basic time unit, such as a one-bit period (e.g., approximately 3.69 microseconds). The parameter N_{TA,offset} may represent a TA defined based on a frequency band. The parameter N_{TA} may represent a TA that may be defined or signaled based on a location of the UE and the TRP or base station.

By way of example, in some wireless communication systems, the TA may be of a value between 0 and 63, with each step between 0 and 63 representing an advance of one-bit period (e.g., approximately 3.69 microseconds). With signals (radio waves) travelling at about 300,000,000 meters per second (i.e., 300 meters per microsecond), one TA step then represents a change in round-trip distance (twice the propagation range) of approximately 1,100 meters. Therefore, in such an example, the TA may change for each 550-meter change in the range between the UE and the TRP/base station.

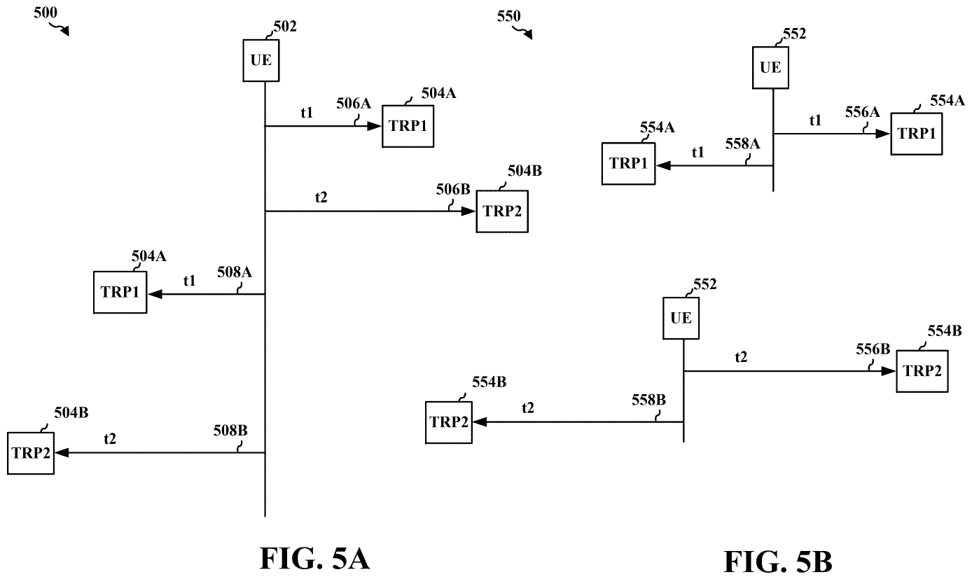

Because TA may be based on a location of the TRP, in mTRP operations, two TAs may be defined for UL transmissions. For example, two TAs may be defined for UL multi-DCI for mTRP operation with two TRPs, a first TRP and a second TRP. FIGS. 5A-5B are diagrams 500 and 550 illustrating single DL timing or separate DL timing. As illustrated in FIG. 5A, in single DL timing, a UE 502 transmit a transmission 506A to a first TRP 504A based on a first TA. In a same channel, the UE 502 may also transmit a transmission 506B to a second TRP 504B based on a second TA. The UE 502 may also transmit another transmission 508A to the first TRP 504A based on the first TA and transmit another transmission 508B to the second TRP 504B based on the second TA in a same channel.

As illustrated in FIG. 5B, in separate DL timing, a UE 552 may transmit a transmission 556A to a first TRP 554A based on a first TA. In the same channel at another time, the UE 552 may transmit another transmission 558A to the first TRP 554A based on the first TA. In a separate channel, the UE 552 may transmit a transmission 556B to a second TRP 554B based on a second TA. In the separate channel at another time, the UE 552 may transmit another transmission 558B to the second TRP 554B based on the second TA.

In some wireless communication systems, TA configuration may be multi-cell and BWP common while mTRP configurations may be CC or BWP specific. Example configurations are provided below:

```
ServingCellConfig ::= SEQUENCE {
  ...
  tag-Id,  TAG-Id
  downlinkBWP-ToReleaseList
  downlinkBWP-ToAddModList
  ...
}
BWP-DownlinkDedicated ::= SEQUENCE {
  pdcch-Config
  ...
}
PDCCH-Config ::= SEQUENCE {
  controlResourceSetToAddModList-r16
  controlResourceSetToReleaseList-r16
  ...
}
ControlResourceSet ::= SEQUENCE {  coresetPoolIndex-r16  INTEGER
(0..1)
  controlResourceSetId-r16
  ...
}
```

As previously described, in an information element (IE) for serving cell configuration (ServingCellConfig), IEs for TAG IDs, a list of BWP configurations of type BWP downlink (downlinkBWP-ToAddModList), and a list of BWPs to be released (downlinkBWP-ToReleaseList) may be included. The list of BWP configurations of type BWP downlink (downlinkBWP-ToAddModList) may correspond with a configuration for configuring the dedicated (UE specific) parameters of a downlink BWP (BWP-DownlinkDedicated). The configuration for configuring the dedicated (UE specific) parameters of a downlink BWP (BWP-DownlinkDedicated) may include a PDCCH configuration (pdcch-Config). The PDCCH configuration (pdcch-Config) may include a list of UE specifically configured Control Resource Sets (CORESETs) to be used by the UE (controlResourceSetToAddModList-r16) and a list of CORESETs to be released by the UE (controlResourceSetToReleaseList-r16). A list of CORESETs may be represented in an IE (ControlResourceSet) that may include a CORESET pool index (coresetPoolIndex-r16) and associated CORESET identifier (ID) (controlResourceSetId-r16). The CORESET pool index of value 0 and 1 may be associated with the first TRP and the second TRP, respectively.

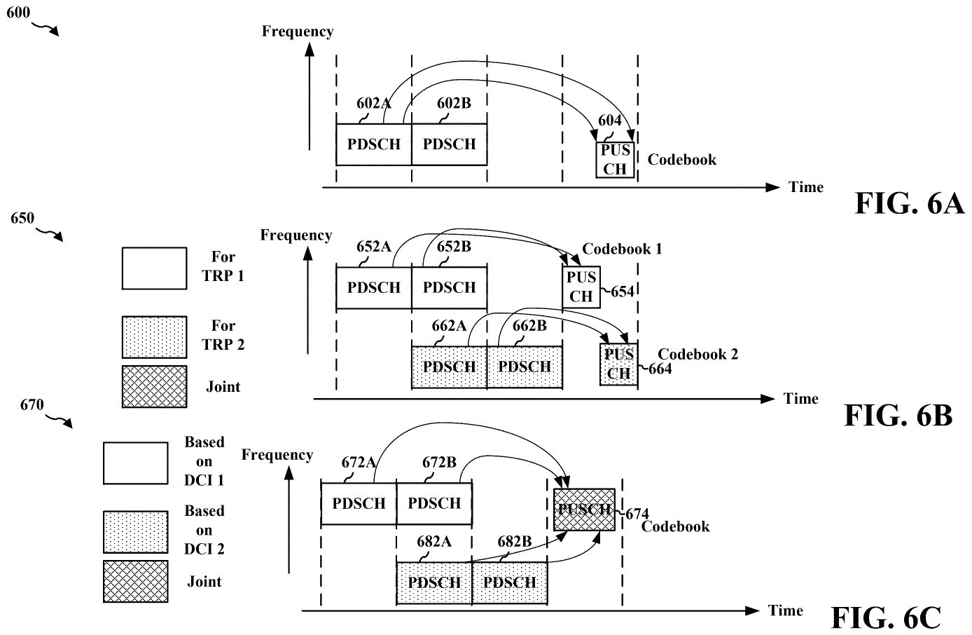

FIGS. 6A, 6B, and 6C are diagrams 600, 650, and 670, respectively, illustrating different BWPs configured with sDCI or mDCI operations or sTRP or mTRP operations. As illustrated in FIG. 6A, for sDCI and UL sTRP operations, in a first BWP associated with a first BWP (e.g., associated with the UL sTRP operations), a first PDSCH 602A and a second PDSCH 602B may be transmitted from the first TRP to the UE. A PUSCH 604 may be transmitted from the UE to the first TRP.

As illustrated in FIG. 6B, for mDCI and UL mTRP operations, a first TRP may be associated with a CORESET pool of index 0 and a second TRP may be associated with a CORESET pool of index 1. A first PDSCH 652A and a second PDSCH 652B based on a first DCI received in a CORESET of a CORESET pool index 0 may be transmitted from the first TRP to the UE. Using different resources, a first PDSCH 662A and a second PDSCH 662B based on a second DCI received in a CORESET of a CORESET pool index 1 may be transmitted from the second TRP to the UE. A first PUSCH 654 based on a first DCI received in a CORESET of a CORESET pool index 0 may be transmitted by the UE to the first TRP and a second PUSCH 664 based on a second DCI received in a CORESET of a CORESET pool index 1 may be transmitted by the UE to the second TRP. The first PUSCH 654 and the second PUSCH 664 may be transmitted at different times or using different frequencies.

As illustrated in FIG. 6C, for mDCI and UL sTRP operations, a first TRP may be associated with a CORESET pool of index 0 and a second TRP may be associated with a CORESET pool of index 1. A first PDSCH 672A and a second PDSCH 672B may be transmitted from a first TRP to the UE based on a first DCI received in a CORESET of a CORESET pool index 0. Using different resources and based on a second DCI, a first PDSCH 682A and a second PDSCH 682B may be transmitted from the second TRP to the UE received in a CORESET of a CORESET pool index 1. A joint PUSCH 674 based on the first DCI and the second DCI may be transmitted by the UE to the first TRP. In some cases, the uplink transmission based on the first DCI received in a CORESET of a CORESET pool index 0 and the second DCI received in a CORESET of a CORESET pool index 1 may be transmitted to only one TRP, either the first TRP or the second TRP in different time occasions. In some other cases, the uplink transmission based on the first DCI received in a CORESET of a CORESET pool index 0 and the second DCI received in a CORESET of a CORESET pool index 1 may be transmitted to one TRP at one time occasion, while may be transmitted to different TRP at different time occasions in a time division multiplexing manner. In some examples, a DCI received in a CORESET of no CORESET pool index may be regarded as a DCI received in a CORESET of a CORESET pool index 0.A TA may be configured (e.g., by a configuration of timing advance group) as common to multiple CC and BWPs for a UE. For sTRP operations in an uplink BWP of a CC, one TA configured by a TAG in the CC is sufficient. For mTRP operations in an uplink BWP of a CC, two TAs configured by two TAGs in the CC may be needed. However, the UE may be configured with mixed sTRP and mTRP operation for different CC and/or BWP. Some aspects provided herein may enable associating different TAs with different UL channels or RS in mDCI mTRP operations. Some aspects provided herein may provide mechanisms for handling 2 TAs for multiple CCs/BWPs with mixed sTRP and mTRP configuration.

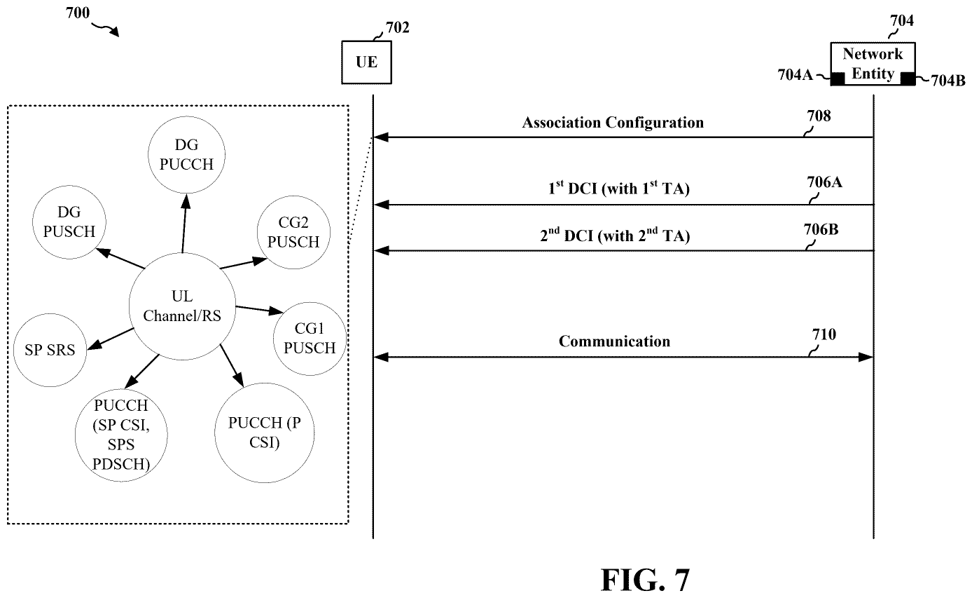

FIG. 7 is a diagram 700 illustrating example communications between a network entity 704 and a UE 702. The network entity may be a network node. A network node may be implemented as an aggregated base station, as a disaggregated base station, an integrated access and backhaul (IAB) node, a relay node, a sidelink node, or the like. A network entity can be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some aspects, the network entity 704 may include a first TRP 704A and a second TRP 704B.

The UE 702 may receive a first DCI 706A that may be associated with (e.g., indicate) a first TA from the network entity 704. In some aspects, the UE 702 may receive a second DCI 706B that may be associated with (e.g., indicate) a second TA from the network entity 704. The UE 702 and the network entity 704 may exchange communication 710 based on the first TA or the second TA. The first TA and the second TA may be associated with the configuration of the first TA group and the second TA group in the serving cell. In some aspects, the first TA and the second TA may be associated with different sets of UL channels. In some aspects, the first TA and the second TA may be associated with different sets of UL channels based on an association configuration defined without signaling. In some aspects, the first TA and the second TA may be associated with different sets of UL channels based on an association configuration 708 transmitted from the network entity 704 to the UE 702 before receiving the first DCI 706A and the second DCI 706B. As illustrated in FIG. 7, by way of example, the UL channels may include dynamic uplink transmissions, semi-persistent uplink transmissions, and periodical uplink transmissions. For example, the dynamic uplink transmissions may include dynamic grant (DG) PUSCH where the PUSCH is dynamically scheduled by a DCI, DG PUCCH where the PUCCH is dynamically transmitted in response to a DCI, and aperiodic SRS. For example, the semi-persistent uplink transmissions may include configured grant (CG) PUSCH of type 2 where the PUSCH may be activated by an activating DCI, PUCCH for semi-persistent channel state information (SP-CSI) report where the PUCCH is to transmit a semi-persistent CSI report, PUSCH for semi-persistent channel state information (SP-CSI) where the PUSCH is to transmit a semi-persistent CSI report, or PUCCH to semi-persistently transmit the acknowledgement for semi-persistent scheduling (SPS) PDSCH, semi-persistent sounding reference signal (SP SRS), or the like. For example, the periodical uplink transmissions may include configured grant (CG) PUSCH of type 1 where the PUSCH may be configured by RRC signaling, PUCCH with periodical channel state information (P-CSI) report where the PUCCH is to transmit a periodical CSI report, and periodical SRS.

In some aspects, to associate the first TA and the second TA with different sets of UL channels, a TAG may be associated with a CORESET pool index. For example, the first TAG may be associated with CORESET pool index 0, and the second TAG in the same CC may be associated with CORESET pool index 1. For different UL channel or RS, the association may be done by different signaling. For example, in some aspects, a scheduling DCI, e.g., scheduling for a dynamic uplink transmissions such as DG PUSCH or DG PUCCH, may associate a TAG with the CORESET pool index for the uplink transmissions. When the UE receives a DCI scheduling a dynamic uplink transmission such as PUSCH, SRS or PUCCH, the UE may determine the TA for the uplink transmission based on a CORESE pool index of the CORESET associated with the DCI. For example, when the UE receives a DCI scheduling a dynamic uplink transmission in a CORESET of a CORESET pool index 0 or of no CORESET pool index, the UE may determine a TA associated with the first TAG to be applied for the dynamic uplink transmission, and when the UE receives a DCI scheduling a dynamic uplink transmission in a CORESET of CORESET pool index 1, the UE may determine a TA associated with the second TAG to be applied for the dynamic uplink transmission. In some other examples, a DCI scheduling a dynamic uplink transmission may include a field to indicate which TA (or TAG-Id) or which CORESET pool index is applied for the uplink transmission.

In another example, in some aspects, an activating signaling, such as DCI or a medium access control (MAC) control element (CE) (MAC-CE), e.g., for a semi-persistent uplink transmission such as SP-SRS, CG PUSCH of type 2, PUCCH or PUSCH for SP-CSI or PUCCH carrying acknowledgement for SPS PDSCH, may associate the TAG with the CORESET pool index for the semi-persistent uplink transmission. When the UE receives an activating DCI activating a semi-persistent uplink transmission, the UE may determine the TA for the uplink transmission based on a CORESE pool index of the CORESET associated with the activating DCI. For example, when the UE receives an activating DCI activating a semi-persistent uplink transmission in a CORESET of a CORESET pool index 0 or of no CORESET pool index, the UE may determine a TA associated with the first TAG to be applied for the semi-persistent uplink transmission, and when the UE receives an activating DCI activating a semi-persistent uplink transmission in a CORESET of a CORESET pool index 1, the UE may determine a TA associated with the second TAG to be applied for the semi-persistent uplink transmission. In some other examples, an activating DCI activating a semi-persistent uplink transmission may include a field to indicate which TA (or TAG ID) or which CORESET pool index is applied for the semi-persistent uplink transmission. The semi-persistent uplink transmission may include such as the PUSCH for SP-CSI report, or the CG PUSCH of type2.

When the UE receives a MAC-CE activating a semi-persistent uplink transmission, the UE may determine the TA for the uplink transmission based on a CORESE pool index of the CORESET associated with the MAC-CE. For example, when the UE receives a MAC-CE activating a semi-persistent uplink transmission in a CORESET of CORESET pool index 0 or of no CORESET pool index, the UE may determine a TA associated with the first TAG to be applied for the semi-persistent uplink transmission, and when the UE receives a MAC-CE activating a semi-persistent uplink transmission in a CORESET of CORESET pool index 1, the UE may determine a TA associated with the second TAG to be applied for the semi-persistent uplink transmission. In some aspects, the CORESET associated with the MAC-CE may be determined based on a CORESET where the UE receives the DCI scheduling a PDSCH which carries the MAC-CE. In some aspects, the MAC-CE activating a semi-persistent uplink transmission may include a field to indicate which TA (or TAG ID) or which CORESET pool index is applied for the semi-persistent uplink transmission. The semi-persistent uplink transmission may include such as the PUCCH for SP-CSI report or the SP-SRS.

In some aspects, a higher layer configuration signaling, such as an RRC or MAC-CE signaling, may indicate which TA (or TAG ID) or which CORESET pool index is applied for the uplink transmission. For example, the RRC signaling configuring a periodical uplink transmission may include a field to indicate which TA (or TAG ID) or which CORESET pool index is applied to the periodical uplink transmission. The periodical uplink transmission may include such as the PUCCH for P-CSI or the P-SRS.

In some aspects, to associate the first TA and the second TA with different sets of UL channels, a TAG may be associated with a close loop index (CLI) of UL channel or RS. In some aspects, the TA to be associated with an uplink channel or reference signal may be determined based on a CLI index included in the power control (PC) parameters indicated for the UL channel or RS. For example, in some aspects, a CLI index of 0 may be associated with a first TA (e.g., TA of lower TAG-Id), and a CLI index of 1 may be associated with a second TA (e.g., TA of higher TAG-Id). When the UE transmit an uplink channel with a CLI index of 0, the UE may determine the TA associated with the lower TAG-Id to be applied to the uplink channel, and when the UE transmit an uplink channel with a CLI index of 1, the UE may determine the TA associated with the higher TAG-Id to be applied to the uplink channel.

In some aspects, to associate the first TA and the second TA with different sets of UL channels, a TAG may be associated with a unified TCI or a unified TCI group. For example, each unified TCI or unified TCI group may be associated with a TAG, and different unified TCIs or different unified TCI groups may be associated with TAGs.

A TCI state may include quasi co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

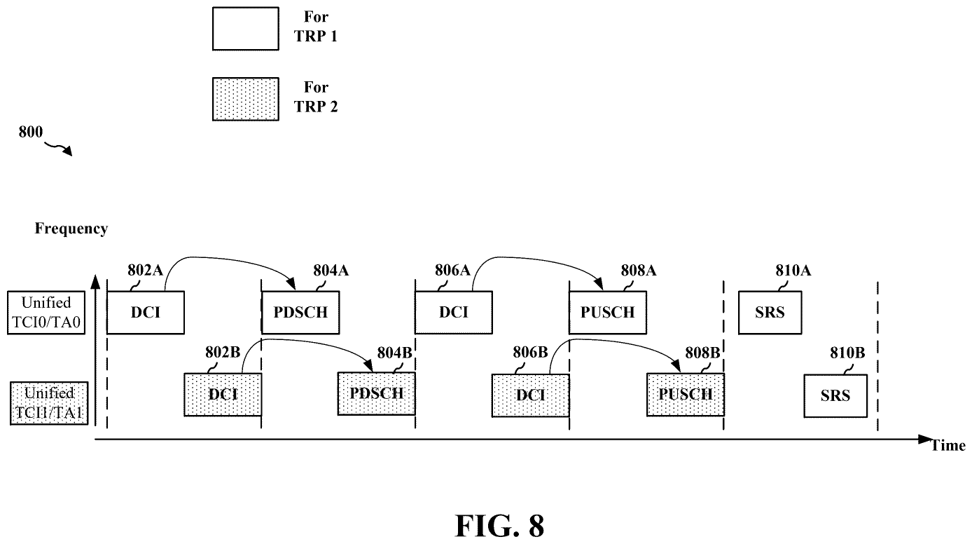

FIG. 8 is a diagram 800 illustrating example associations of TAG with unified TCI. In some aspects, TCIs with a root RS from serving-cell or non-serving cell may be associated with different TAs. For example, in some aspects, a first TCI with serving-cell SSB as a root QCL RS may be associated with a first TA (e.g., TA of lower TAG-Id), and a second TCI with non-Serving-cell SSB as a root QCL RS may be associated with a second TA (e.g., TA of higher TAG-Id). As another example, in some aspects, a first half of TCIs in TCI pool may be associated with a first TA (e.g., TA of lower TAG-Id), and a second half of TCIs in TCI pool may be associated with the second TA (e.g., TA of higher TAG-Id). In some aspects, the association indication may be included in TCI configuration, or TCI pool configuration, or TCI activation MAC-CE. As illustrated in FIG. 8, DCI 802A and associated PDSCH 804A may be transmitted based on the unified TCI 0, which may be associated with a first TA 0. A PUSCH 808A associated with DCI 806A may be transmitted based on the first TA 0 and an SRS 810A may also be transmitted based on the first TA 0. DCI 802B and associated PDSCH 804B may be transmitted based on the unified TCI 1, which may be associated with a second TA 1. A PUSCH 808B associated with DCI 806B may be transmitted based on the second TA 1 and an SRS 810B may also be transmitted based on the second TA 1.

In some aspects, if a single TA may be used without a second TA while two TAs may be configured for the UE 702, the UE 702 may determine one TA for a BWP, CC, or TRP. In some aspects, when the first UL BWP in a first CC involves an sTRP operation without another TRP, the UE 702 may be indicated with a TA command associated with the sTRP. The UE 702 may apply the related TA to the UL transmission for the single TRP based on the TA command.

In some aspects, when the UE 702 receives a second TA command associated with a second TRP for a second CC or BWP, the UE 702 may ignore the second TA command's application to the first CC or BWP. For example, the UE 702 may be configured with CORESET pool index 0 and 1 for CORESETs in BWP1 of CC1 and configured with only CORESET pool index 1 for CORESETs in BWP2 of CC2. The UE 702 may be configured with two TAGs of Tag-Id0 and Tag-Id1 for both CC1 and CC2. In some aspects, the UE 702 may apply TA commands for Tag-Id0 and Tag-Id1 to BWP1 of CC1, and apply TA commands for Tag-Id1 to BWP2 of CC2.

In some aspects, the UE 702 may be configured with serving cell SSBs and non-serving cell SSBs as root QCL source RS for TCIs in BWP1 of CC1, and configured with serving cell SSBs as root QCL source RS for TCIs in BWP2 of CC2. In some aspects, the UE 702 may be configured with two TAG of Tag-Id0 and Tag-Id1 for CC1 and CC2. In some aspects, the UE 702 may apply TA commands for Tag-Id0 and Tag-Id1 to BWP1 or CC1, and apply TA commands for Tag-Id0 to BWP2 or CC2.

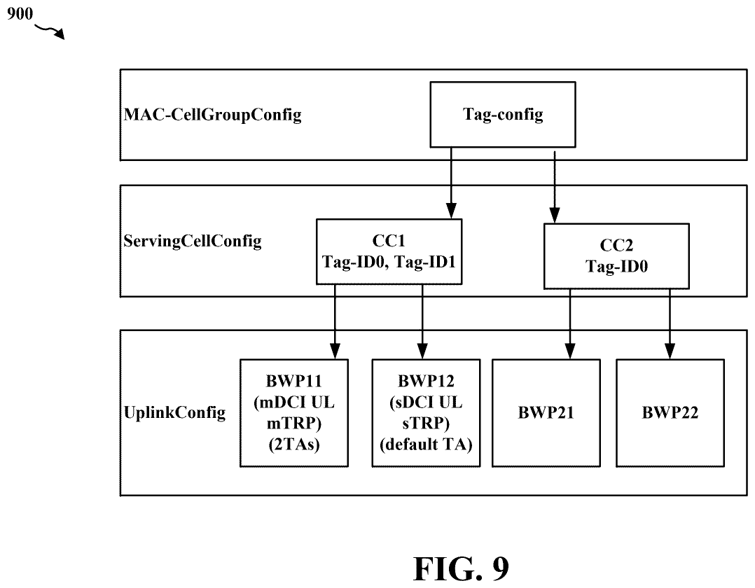

In some aspects, the UE or network entity 704 may apply a default TA to a BWP and/or CC when UL involves a single TRP without another TRP. In some aspects, default TA may be applied when sTRP operation is configured for UL. In some aspects, the default TA may have a TAG of lower ID in the multiple TAGs configured in the same CC. FIG. 9 is a diagram 900 illustrating wireless communications with supporting a default TA to a BWP and/or CC where UL involves a single TRP. As illustrated in FIG. 9, a cell group configuration (MAC-CellGroupConfig) including a TAG configuration (Tag-config) may indicate multiple TAG configurations for two different CCs (CC1 and CC2) configured by a serving cell configuration (ServingCellConfig). The first CC may be associated with two different TAG IDs and the second CC may be associated with one TAG ID. For a BWP configured with sTRP operation, i.e., not configured with mDCI mTRP operation in uplink, the UE may apply a default TA for the BWP associated with the sTRP operations. For example, the default TA may be the TA associated with a lower TAG ID, or the TA associated with the lower CORESET pool index.

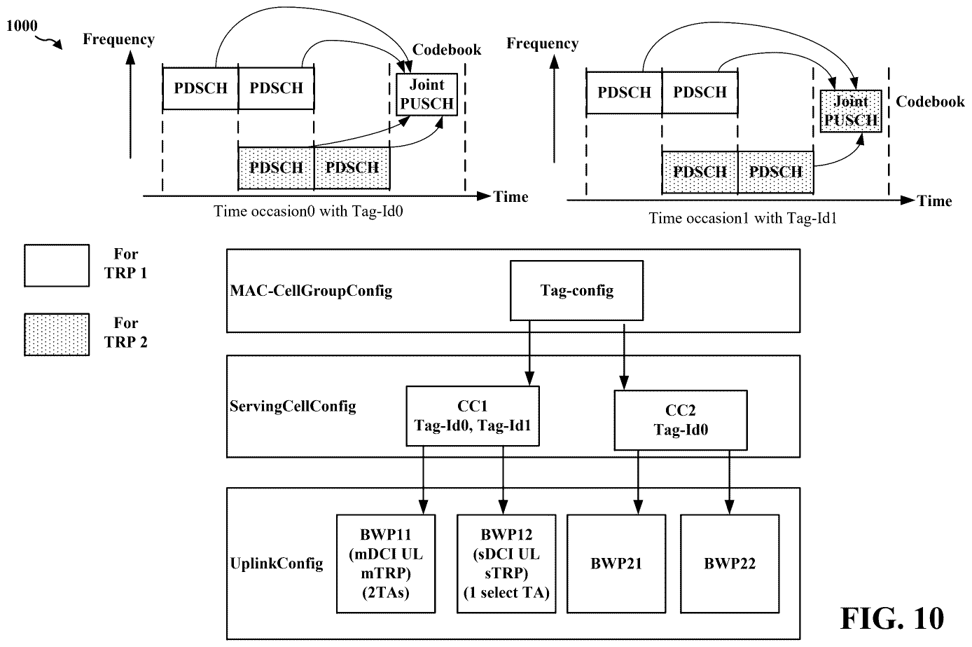

In some aspects, the network entity 704 may indicate whether a BWP and/or CC may be applied with two TAs or a single selected TA. For example, even if sTRP operation is configured for UL, UL may be scheduled for different TRPs, and may applied with two TAs for two TRPs. In some examples, mDCI mTRP operation may schedule any of two TRPs in UL transmission in a TDM manner. In some examples, mDCI mTRP operation may schedule only one TRP in UL transmission. FIG. 10 is a diagram 1000 illustrating wireless communications with indicating whether a BWP or CC to be applied with two TAs or a single selected TA. The network entity 704 may indicate to the UE which TA to be applied for the uplink transmission in a BWP and/CC in the time occasions. As illustrated in FIG. 10, in a first time occasion, a joint PUSCH in a BWP of a CC may be transmitted based on a first TA associated with a first TAG ID (time occasion0 with tag-Id0). In a second time occasion, a joint PUSCH in the same BWP of the CC may be transmitted based on a second TA associated with a second TAG ID (time occasion1 with tag-Id1).

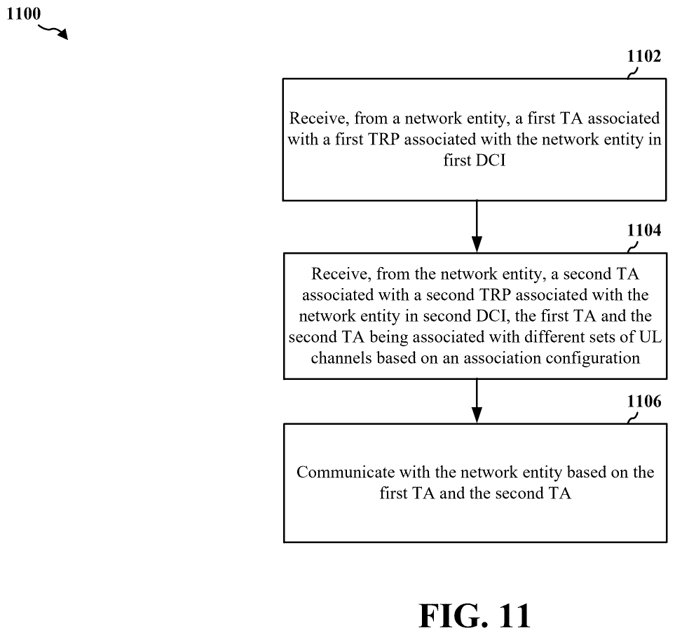

FIG. 11 is a flowchart 1100 of a method of wireless communication. The method may be performed by a UE (e.g., the UE 104, the UE 702; the apparatus 1702).

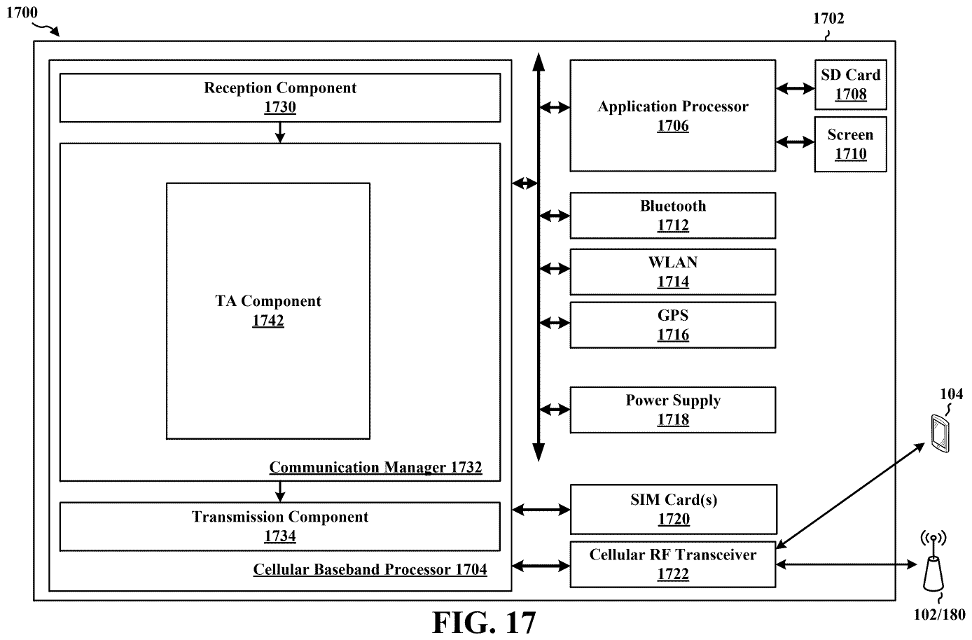

At 1102, the UE may receive, from a network entity, a first TA associated with a first TRP associated with the network entity in first DCI. For example, the UE 702 may receive, from a network entity 704, a first TA associated with a first TRP associated with the network entity in first DCI 706A. In some aspects, 1102 may be performed by TA component 1742 in FIG. 17.

At 1104, the UE may receive, from the network entity, a second TA associated with a second TRP associated with the network entity in second DCI. In some aspects, the first TA and the second TA may be associated with different sets of UL channels based on an association configuration. For example, the UE 702 may receive, from the network entity 704, a second TA associated with a second TRP associated with the network entity in second DCI 706B. In some aspects, 1104 may be performed by TA component 1742 in FIG. 17.

At 1106, the UE may communicate with the network entity based on the first TA and the second TA. For example, the UE 702 may communicate with the network entity 704 based on the first TA and the second TA by exchanging communication 710. In some aspects, 1106 may be performed by TA component 1742 in FIG. 17.

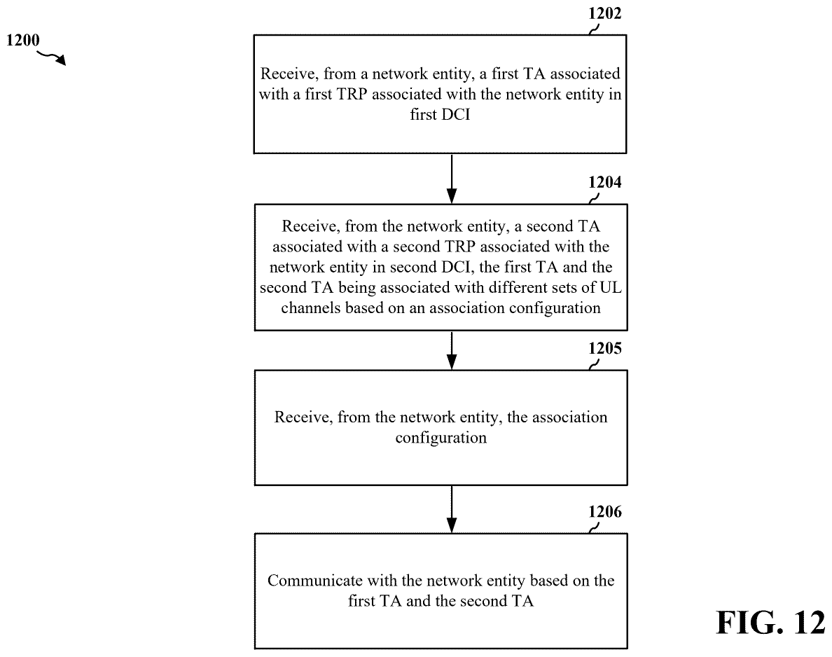

FIG. 12 is a flowchart 1200 of a method of wireless communication. The method may be performed by a UE (e.g., the UE 104, the UE 702; the apparatus 1702).

At 1202, the UE may receive, from a network entity, a first TA associated with a first TRP associated with the network entity in first DCI. For example, the UE 702 may receive, from a network entity 704, a first TA associated with a first TRP associated with the network entity in first DCI 706A. In some aspects, 1202 may be performed by TA component 1742 in FIG. 17.

At 1204, the UE may receive, from the network entity, a second TA associated with a second TRP associated with the network entity in second DCI. In some aspects, the first TA and the second TA may be associated with different sets of UL channels based on an association configuration. For example, the UE 702 may receive, from the network entity 704, a second TA associated with a second TRP associated with the network entity in second DCI 706B. In some aspects, 1204 may be performed by TA component 1742 in FIG. 17.

At 1205, the UE may receive, from the network entity, the association configuration. For example, the UE 702 may receive, from the network entity 704, the association configuration 708. In some aspects, 1205 may be performed by TA component 1742 in FIG. 17. In some aspects, the association configuration may be based on an association between a TAG and a CORESET pool index. In some aspects, the association configuration may be received via scheduling DCI for a DG PUSCH or a PUCCH. In some aspects, the scheduling DCI may be associated with the CORESET pool index. In some aspects, the association configuration may be received via activating signaling, the activating signaling may be DCI or MAC-CE for a SP-SRS, a CG PUSCH, a PUCCH for SP-CSI, or a SPS PDSCH. In some aspects, the association configuration may be received via a higher layer configuration, the higher layer configuration may be RRC signaling or MAC-CE for a PUCCH for P-CSI or P-SRS. In some aspects, the association configuration may be based on an association between a TAG and a closed loop index associated with the different sets of UL channels or associated RS. In some aspects, the association configuration may be further based on an association between one or more CLI and the first TA or the second TA. In some aspects, the association configuration may be based on an association between a TAG and a unified TCI or a unified TCI group. In some aspects, a serving-cell SSB or a first non-serving-cell SSB in a root RS of the unified TCI may be associated with the first TA while one or more SSBs of a second non-serving-cell SSB in a non-root RS of the unified TCI are associated with the second TA.

At 1206, the UE may communicate with the network entity based on the first TA and the second TA. For example, the UE 702 may communicate with the network entity 704 based on the first TA and the second TA by exchanging communication 710. In some aspects, 1206 may be performed by TA component 1742 in FIG. 17.

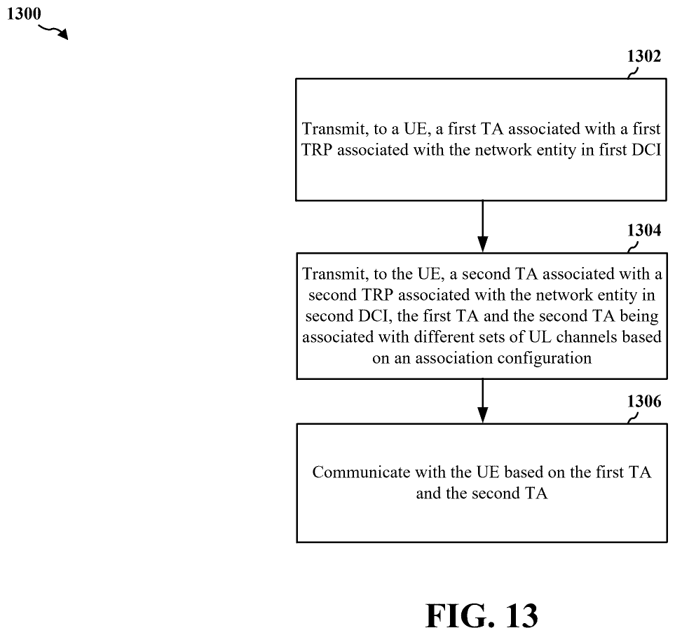

FIG. 13 is a flowchart 1300 of a method of wireless communication. The method may be performed by a network entity (e.g., the base station 102/180, the network entity 704; the apparatus 1802).

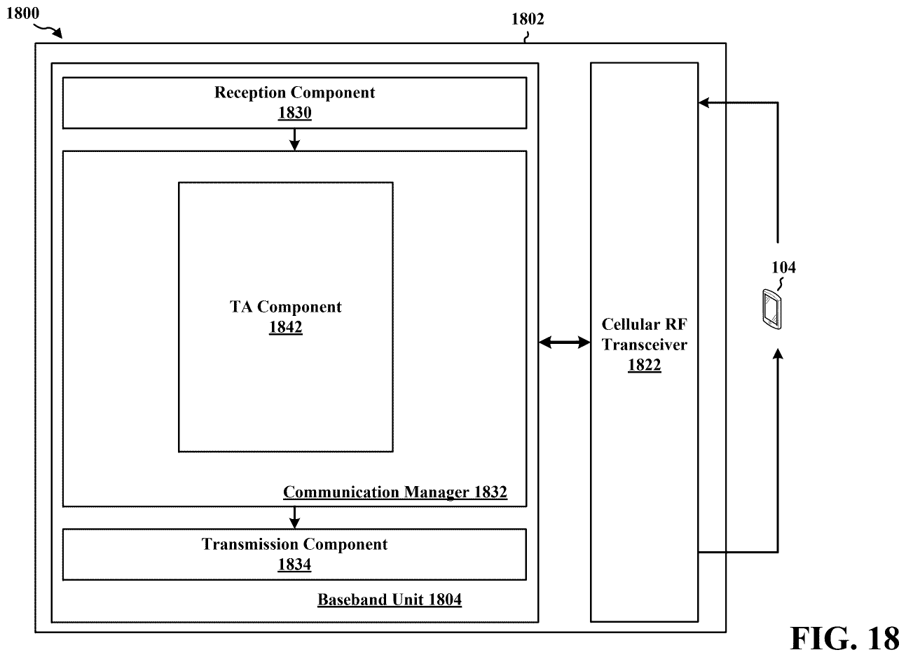

At 1302, the network entity may transmit, to a UE, a first TA associated with a first TRP associated with the network entity in first DCI. For example, the network entity 704 may transmit, to a UE 702, a first TA associated with a first TRP associated with the network entity in first DCI 706A. In some aspects, 1302 may be performed by TA component 1842 in FIG. 18.

At 1304, the network entity may transmit, to the UE, a second TA associated with a second TRP associated with the network entity in second DCI. In some aspects, the first TA and the second TA may be associated with different sets of UL channels based on an association configuration. For example, the network entity 704 may transmit, to the UE 702, a second TA associated with a second TRP associated with the network entity in second DCI 706B. In some aspects, 1304 may be performed by TA component 1842 in FIG. 18.

At 1306, the network entity may communicate with the UE based on the first TA and the second TA. For example, the network entity 704 may communicate with the UE 702 based on the first TA and the second TA by exchanging communication 710. In some aspects, 1306 may be performed by TA component 1842 in FIG. 18.

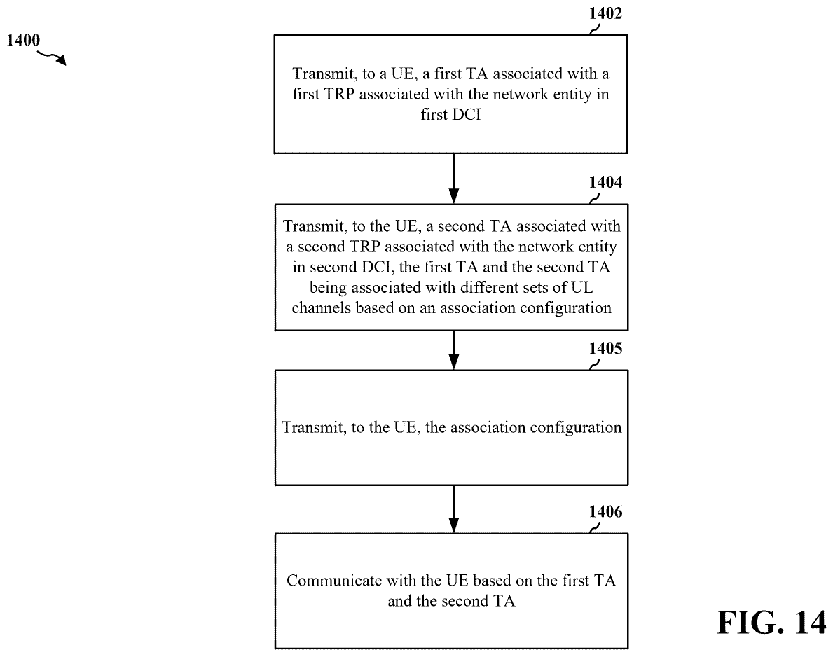

FIG. 14 is a flowchart 1400 of a method of wireless communication. The method may be performed by a network entity (e.g., the base station 102/180, the network entity 704; the apparatus 1802).

At 1402, the network entity may transmit, to a UE, a first TA associated with a first TRP associated with the network entity in first DCI. For example, the network entity 704 may transmit, to a UE 702, a first TA associated with a first TRP associated with the network entity in first DCI 706A. In some aspects, 1402 may be performed by TA component 1842 in FIG. 18.

At 1404, the network entity may transmit, to the UE, a second TA associated with a second TRP associated with the network entity in second DCI. In some aspects, the first TA and the second TA may be associated with different sets of UL channels based on an association configuration. For example, the network entity 704 may transmit, to the UE 702, a second TA associated with a second TRP associated with the network entity in second DCI 706B. In some aspects, 1404 may be performed by TA component 1842 in FIG. 18.

At 1405, the network entity may transmit, to the UE, the association configuration. For example, the network entity 704 may transmit, to the UE 702, the association configuration 708. In some aspects, 1405 may be performed by TA component 1842 in FIG. 18. In some aspects, the association configuration may be based on an association between a TAG and a CORESET pool index. In some aspects, the association configuration may be received via scheduling DCI for a DG PUSCH or a PUCCH. In some aspects, the scheduling DCI may be associated with the CORESET pool index. In some aspects, the association configuration may be received via activating signaling, the activating signaling may be DCI or MAC-CE for a SP-SRS, a CG PUSCH, a PUCCH for SP-CSI, or a SPS PDSCH. In some aspects, the association configuration may be received via a higher layer configuration, the higher layer configuration may be RRC signaling or MAC-CE for a PUCCH for P-CSI or P-SRS. In some aspects, the association configuration may be based on an association between a TAG and a closed loop index associated with the different sets of UL channels or associated RS. In some aspects, the association configuration may be further based on an association between one or more CLI and the first TA or the second TA. In some aspects, the association configuration may be based on an association between a TAG and a unified TCI or a unified TCI group. In some aspects, a serving-cell SSB or a first non-serving-cell SSB in a root RS of the unified TCI may be associated with the first TA while one or more SSBs of a second non-serving-cell SSB in a non-root RS of the unified TCI are associated with the second TA.

At 1406, the network entity may communicate with the UE based on the first TA and the second TA. For example, the network entity 704 may communicate with the UE 702 based on the first TA and the second TA by exchanging communication 710. In some aspects, 1406 may be performed by TA component 1842 in FIG. 18.

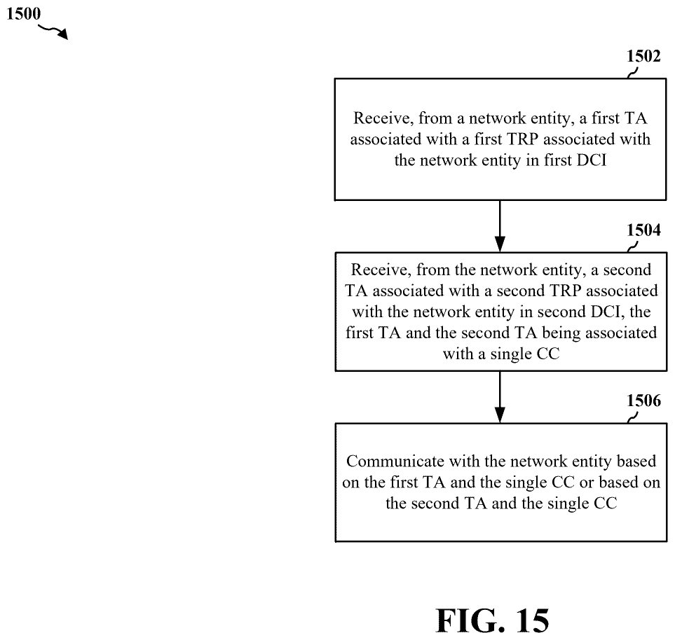

FIG. 15 is a flowchart 1500 of a method of wireless communication. The method may be performed by a UE (e.g., the UE 104, the UE 702; the apparatus 1702).

At 1502, the UE may receive, from a network entity, a first TA associated with a first TRP associated with the network entity in first DCI. For example, the UE 702 may receive, from a network entity 704, a first TA associated with a first TRP associated with the network entity in first DCI 706A. In some aspects, 1502 may be performed by TA component 1742 in FIG. 17.

At 1504, the UE may receive, from the network entity, a second TA associated with a second TRP associated with the network entity in second DCI. In some aspects, the first TA and the second TA may be associated with a single CC. For example, the UE 702 may receive, from the network entity 704, a second TA associated with a second TRP associated with the network entity in second DCI 706B. In some aspects, 1504 may be performed by TA component 1742 in FIG. 17.

At 1506, the UE may communicate with the network entity based on the first TA and the single CC or based on the second TA and the single CC. For example, the UE 702 may communicate with the network entity 704 based on the first TA and the single CC or based on the second TA and the single CC by exchanging communication 710. In some aspects, 1506 may be performed by TA component 1742 in FIG. 17. In some aspects, the UE may communicate with the network entity based on the first TA without may be based on the second TA when a first BWP in the single CC may be related to the first TRP without may be related to the second TRP. In some aspects, the UE may communicate with the network entity based on a default TA of the first TA or the second TA. In some aspects, the default TA may be associated with a lower TAG ID. In some aspects, the UE may communicate with the network entity based on an indication of the first TA or the second TA.

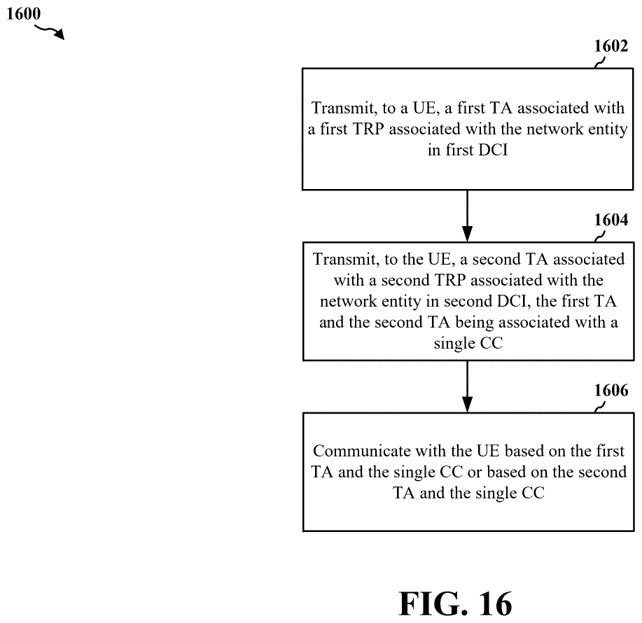

FIG. 16 is a flowchart 1600 of a method of wireless communication. The method may be performed by a network entity (e.g., the base station 102/180, the network entity 704; the apparatus 1802).

At 1602, the network entity may transmit, to a UE, a first TA associated with a first TRP associated with the network entity in first DCI. For example, the network entity 704 may transmit, to a UE 702, a first TA associated with a first TRP associated with the network entity in first DCI 706A. In some aspects, 1602 may be performed by TA component 1842 in FIG. 18.

At 1604, the network entity may transmit, to the UE, a second TA associated with a second TRP associated with the network entity in second DCI. In some aspects, the first TA and the second TA may be associated with a single CC. For example, the network entity 704 may transmit, to the UE 702, a second TA associated with a second TRP associated with the network entity in second DCI 706B. In some aspects, 1604 may be performed by TA component 1842 in FIG. 18.

At 1606, the network entity may communicate with the UE based on the first TA and the single CC or based on the second TA and the single CC. For example, the network entity 704 may communicate with the UE 702 based on the first TA and the single CC or based on the second TA and the single CC by exchanging communication 710. In some aspects, 1606 may be performed by TA component 1842 in FIG. 18. In some aspects, the network entity may communicate with the UE based on the first TA without may be based on the second TA when a first BWP in the single CC may be related to the first TRP without may be related to the second TRP. In some aspects, the network entity may communicate with the UE based on a default TA of the first TA or the second TA. In some aspects, the default TA may be associated with a lower TAG ID. In some aspects, the network entity may communicate with the UE based on an indication of the first TA or the second TA.

FIG. 17 is a diagram 1700 illustrating an example of a hardware implementation for an apparatus 1702. The apparatus 1702 may be a UE, a component of a UE, or may implement UE functionality. In some aspects, the apparatus 1702 may include a cellular baseband processor 1704 (also referred to as a modem) coupled to a cellular RF transceiver 1722. In some aspects, the apparatus 1702 may further include one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, or a power supply 1718. The cellular baseband processor 1704 communicates through the cellular RF transceiver 1722 with the UE 104 and/or BS 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704. The cellular baseband processor 1704 may be a component of the UE 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire UE (e.g., see 350 of FIG. 3) and include the additional modules of the apparatus 1702.

The communication manager 1732 may include a TA component 1742 that may receive, from a network entity, a first TA associated with a first TRP associated with the network entity in first DCI, e.g., as described in connection with 1102 in FIGS. 11 and 1202 in FIG. 12. In some aspects, the TA component 1742 may receive, from the network entity, a second TA associated with a second TRP associated with the network entity in second DCI, the first TA and the second TA being associated with different sets of UL channels based on an association configuration, e.g., as described in connection with 1104 in FIGS. 11 and 1204 in FIG. 12. In some aspects, the TA component 1742 may communicate with the network entity based on the first TA and the second TA, e.g., as described in connection with 1106 in FIGS. 11 and 1206 in FIG. 12. In some aspects, the TA component 1742 may receive, from the network entity, the association configuration, e.g., as described in connection with 1205 in FIG. 12. In some aspects, the TA component 1742 may receive, from a network entity, a first TA associated with a first TRP associated with the network entity in first DCI, e.g., as described in connection with 1502 in FIG. 15. In some aspects, the TA component 1742 may receive, from the network entity, a second TA associated with a second TRP associated with the network entity in second DCI, the first TA and the second TA being associated with a single CC, e.g., as described in connection with 1504 in FIG. 15. In some aspects, the TA component 1742 may communicate with the network entity based on the first TA and the single CC or based on the second TA and the single CC, e.g., as described in connection with 1506 in FIG. 15.

The apparatus may include additional components that perform each of the blocks of the algorithm in the flowcharts of FIGS. 11-12 and 15. As such, each block in the flowcharts of FIGS. 11-12 and 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the cellular baseband processor 1704, may include means for transmitting, to a UE, a first TA associated with a first TRP associated with the network entity in first DCI. The cellular baseband processor 1704 may further include means for transmitting, to the UE, a second TA associated with a second TRP associated with the network entity in second DCI, the first TA and the second TA being associated with different sets of UL channels based on an association configuration. The cellular baseband processor 1704 may further include means for communicating with the UE based on the first TA and the second TA. The cellular baseband processor 1704 may further include means for transmitting, to the UE, the association configuration. The cellular baseband processor 1704 may further include means for transmitting, to a UE, a first TA associated with a first TRP associated with the network entity in first DCI. The cellular baseband processor 1704 may further include means for transmitting, to the UE, a second TA associated with a second TRP associated with the network entity in second DCI, the first TA and the second TA being associated with a single CC. The cellular baseband processor 1704 may further include means for communicating with the UE based on the first TA and the single CC or based on the second TA and the single CC. The means may be one or more of the components of the apparatus 1702 configured to perform the functions recited by the means. As described supra, the apparatus 1702 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 18 is a diagram 1800 illustrating an example of a hardware implementation for an apparatus 1802. The apparatus 1802 may be a network entity, such as a RU, a DU, base station, a component of a base station, or may implement base station functionality. In some aspects, the apparatus 1802 may include a baseband unit 1804. The baseband unit 1804 may communicate through a cellular RF transceiver 1822 with the UE 104. The baseband unit 1804 may include a computer-readable medium/memory. The baseband unit 1804 is responsible for general processing, including the execution of software stored on the computer-readable medium/memory. The software, when executed by the baseband unit 1804, causes the baseband unit 1804 to perform the various functions described supra. The computer-readable medium/memory may also be used for storing data that is manipulated by the baseband unit 1804 when executing software. The baseband unit 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the baseband unit 1804. The baseband unit 1804 may be a component of the base station 310 and may include the memory 376 and/or at least one of the TX processor 316, the RX processor 370, and the controller/processor 375.

The communication manager 1832 may include a TA component 1842 that may transmit, to a UE, a first TA associated with a first TRP associated with the network entity in first DCI, e.g., as described in connection with 1302 in FIGS. 13 and 1402 in FIG. 14. In some aspects, the TA component 1842 may transmit, to the UE, a second TA associated with a second TRP associated with the network entity in second DCI, the first TA and the second TA being associated with different sets of UL channels based on an association configuration, e.g., as described in connection with 1304 in FIGS. 13 and 1404 in FIG. 14. In some aspects, the TA component 1842 may communicate with the UE based on the first TA and the second TA, e.g., as described in connection with 1306 in FIGS. 13 and 1406 in FIG. 14. In some aspects, the TA component 1842 may transmit, to the UE, the association configuration, e.g., as described in connection with 1405 in FIG. 14. In some aspects, the TA component 1842 may transmit, to a UE, a first TA associated with a first TRP associated with the network entity in first DCI, e.g., as described in connection with 1602 in FIG. 16. In some aspects, the TA component 1842 may transmit, to the UE, a second TA associated with a second TRP associated with the network entity in second DCI, the first TA and the second TA being associated with a single CC, e.g., as described in connection with 1604 in FIG. 16. In some aspects, the TA component 1842 may communicate with the UE based on the first TA and the single CC or based on the second TA and the single CC, e.g., as described in connection with 1606 in FIG. 16.

The apparatus may include additional components that perform each of the blocks of the algorithm in the flowcharts of FIGS. 13-14 and 16. As such, each block in the flowcharts of FIGS. 13-14 and 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the baseband unit 1804, may include means for transmitting, to a UE, a first TA associated with a first TRP associated with the network entity in first DCI. The baseband unit 1804 may further include means for transmitting, to the UE, a second TA associated with a second TRP associated with the network entity in second DCI, the first TA and the second TA being associated with different sets of UL channels based on an association configuration. The baseband unit 1804 may further include means for communicating with the UE based on the first TA and the second TA. The baseband unit 1804 may further include means for transmitting, to the UE, the association configuration. The baseband unit 1804 may further include means for transmitting, to a UE, a first TA associated with a first TRP associated with the network entity in first DCI. The baseband unit 1804 may further include means for transmitting, to the UE, a second TA associated with a second TRP associated with the network entity in second DCI, the first TA and the second TA being associated with a single CC. The baseband unit 1804 may further include means for communicating with the UE based on the first TA and the single CC or based on the second TA and the single CC.

The means may be one or more of the components of the apparatus 1802 configured to perform the functions recited by the means. As described supra, the apparatus 1802 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, comprising: memory; and at least one processor coupled to the memory and configured to: receive, from a network entity, a first TA associated with a first TRP associated with the network entity in first DCI; receive, from the network entity, a second TA associated with a second TRP associated with the network entity in second DCI, the first TA and the second TA may be associated with different sets of UL channels based on an association configuration; and communicate with the network entity based on the first TA and the second TA.

Aspect 2 is the apparatus of aspect 1, wherein the at least one processor may be further configured to: receive, from the network entity, the association configuration.

Aspect 3 is the apparatus of any of aspects 1-2, wherein the association configuration may be based on an association between a TAG and a CORESET pool index.

Aspect 4 is the apparatus of any of aspects 1-3, wherein the association configuration may be received via scheduling DCI for a DG PUSCH or a PUCCH.

Aspect 5 is the apparatus of any of aspects 1-4, wherein the scheduling DCI may be associated with the CORESET pool index.

Aspect 6 is the apparatus of any of aspects 1-3, wherein the association configuration may be received via activating signaling, the activating signaling may be DCI or MAC-CE for a SP-SRS, a CG PUSCH, a PUCCH for SP-CSI, or a SPS PDSCH.

Aspect 7 is the apparatus of any of aspects 1-3, wherein the association configuration may be received via a higher layer configuration, the higher layer configuration may be RRC signaling or MAC-CE for a PUCCH for P-CSI or P-SRS.

Aspect 8 is the apparatus of any of aspects 1-2, wherein the association configuration may be based on an association between a TAG and a closed loop index associated with the different sets of UL channels or associated RS.

Aspect 9 is the apparatus of any of aspects 1-8, wherein the association configuration may be further based on an association between one or more CLI and the first TA or the second TA.

Aspect 10 is the apparatus of any of aspects 1-2, wherein the association configuration may be based on an association between a TAG and a unified TCI or a unified TCI group.

Aspect 11 is the apparatus of any of aspects 1-10, wherein a serving-cell SSB or a first non-serving-cell SSB in a root RS of the unified TCI may be associated with the first TA while one or more SSBs of a second non-serving-cell SSB in a non-root RS of the unified TCI are associated with the second TA.

Aspect 12 is the apparatus of any of aspects 1-11, further comprising at least one transceiver coupled to the at least one processor.

Aspect 13 is an apparatus for wireless communication at a UE, comprising: memory; and at least one processor coupled to the memory and configured to: receive, from a network entity, a first TA associated with a first TRP associated with the network entity in first DCI; receive, from the network entity, a second TA associated with a second TRP associated with the network entity in second DCI, the first TA and the second TA may be associated with a single CC; and communicate with the network entity based on the first TA and the single CC or based on the second TA and the single CC.

Aspect 14 is the apparatus of aspect 13, wherein the at least one processor may be configured to communicate with the network entity based on the first TA without may be based on the second TA when a first BWP in the single CC may be related to the first TRP without may be related to the second TRP.

Aspect 15 is the apparatus of any of aspects 13-14, wherein the at least one processor may be configured to communicate with the network entity based on a default TA of the first TA or the second TA.

Aspect 16 is the apparatus of any of aspects 13-15, wherein the default TA may be associated with a lower TAG ID.

Aspect 17 is the apparatus of any of aspects 13-16, wherein the at least one processor may be configured to communicate with the network entity based on an indication of the first TA or the second TA.

Aspect 18 is the apparatus of any of aspects 13-17, further comprising at least one transceiver coupled to the at least one processor.

Aspect 19 is an apparatus for wireless communication at a network entity, comprising: memory; and at least one processor coupled to the memory and configured to: transmit, to a UE, a first TA associated with a first TRP associated with the network entity in first DCI; transmit, to the UE, a second TA associated with a second TRP associated with the network entity in second DCI, the first TA and the second TA may be associated with different sets of UL channels based on an association configuration; and communicate with the UE based on the first TA and the second TA.

Aspect 20 is the apparatus of aspect 19, further comprising at least one transceiver coupled to the at least one processor.

Aspect 21 is the apparatus of any of aspects 19-20, wherein the at least one processor may be further configured to: transmit, to the UE, the association configuration.

Aspect 22 is the apparatus of any of aspects 19-21, wherein the association configuration may be based on an association between a TAG and a CORESET pool index.

Aspect 23 is the apparatus of any of aspects 19-22, wherein the association configuration may be received via scheduling DCI for a DG PUSCH or a PUCCH.

Aspect 24 is the apparatus of any of aspects 19-23, wherein the scheduling DCI may be associated with the CORESET pool index.

Aspect 25 is the apparatus of any of aspects 19-22, wherein the association configuration may be received via activating signaling, the activating signaling may be DCI or MAC-CE for a SP-SRS, a CG PUSCH, a PUCCH for SP-CSI, or a SPS PDSCH.

Aspect 26 is the apparatus of any of aspects 19-22, wherein the association configuration may be received via a higher layer configuration, the higher layer configuration may be RRC signaling or MAC-CE for a PUCCH for P-CSI or P-SRS.

Aspect 27 is the apparatus of any of aspects 19-21, wherein the association configuration may be based on an association between a TAG and a closed loop index associated with the different sets of UL channels or associated RS.

Aspect 28 is the apparatus of any of aspects 19-27, wherein the association configuration may be further based on an association between one or more CLI and the first TA or the second TA.

Aspect 29 is an apparatus for wireless communication at a network entity, comprising: memory; and at least one processor coupled to the memory and configured to: transmit, to a UE, a first TA associated with a first TRP associated with the network entity in first DCI; transmit, to the UE, a second TA associated with a second TRP associated with the network entity in second DCI, the first TA and the second TA may be associated with a single CC; and communicate with the UE based on the first TA and the single CC or based on the second TA and the single CC.

Aspect 30 is the apparatus of aspect 29, further comprising at least one transceiver coupled to the at least one processor, wherein the at least one processor may be configured to communicate with the UE based on the first TA without may be based on the second TA when a first BWP in the single CC may be related to the first TRP without may be related to the second TRP.

Aspect 31 is the apparatus of any of aspects 29-30, wherein the at least one processor may be configured to communicate with the network entity based on a default TA of the first TA or the second TA.

Aspect 32 is the apparatus of any of aspects 29-31, wherein the default TA may be associated with a lower TAG ID.

Aspect 33 is the apparatus of any of aspects 29-32, wherein the at least one processor may be configured to communicate with the network entity based on an indication of the first TA or the second TA.

Aspect 34 is the apparatus of any of aspects 29-33, further comprising at least one transceiver coupled to the at least one processor.

Aspect 35 is a method of wireless communication for implementing any of aspects 1 to 12.

Aspect 36 is an apparatus for wireless communication including means for implementing any of aspects 1 to 12.

Aspect 37 is a computer-readable medium storing computer executable code, where the code when executed by a processor causes the processor to implement any of aspects 1 to 12.

Aspect 38 is a method of wireless communication for implementing any of aspects 13 to 18.

Aspect 39 is an apparatus for wireless communication including means for implementing any of aspects 13 to 18.

Aspect 40 is a computer-readable medium storing computer executable code, where the code when executed by a processor causes the processor to implement any of aspects 13 to 18.

Aspect 41 is a method of wireless communication for implementing any of aspects 19 to 28.

Aspect 42 is an apparatus for wireless communication including means for implementing any of aspects 19 to 28.

Aspect 43 is a computer-readable medium storing computer executable code, where the code when executed by a processor causes the processor to implement any of aspects 19 to 28.

Aspect 44 is a method of wireless communication for implementing any of aspects 29 to 34.

Aspect 45 is an apparatus for wireless communication including means for implementing any of aspects 29 to 34.

Aspect 46 is a computer-readable medium storing computer executable code, where the code when executed by a processor causes the processor to implement any of aspects 29 to 34.

What is claimed is:

1. An apparatus for wireless communication at a user equipment (UE), comprising:
memory; and
at least one processor coupled to the memory and configured to:
receive, from a network entity, a first timing advance (TA) associated with a first transmission reception point (TRP) associated with the network entity in first downlink control information (DCI);
receive, from the network entity, a second TA associated with a second TRP associated with the network entity in second DCI, the first TA and the second TA being associated with different sets of uplink (UL) channels based on an association configuration; and
communicate with the network entity based on the first TA and the second TA.

2. The apparatus of claim 1, wherein the at least one processor is further configured to:
receive, from the network entity, the association configuration.

3. The apparatus of claim 2, wherein the association configuration is based on an association between a timing advance group (TAG) and a control resource set (CORESET) pool index.

4. The apparatus of claim 3, wherein the association configuration is received via scheduling DCI for a dynamic grant (DG) physical uplink shared channel (PUSCH) or a physical uplink control channel (PUCCH).

5. The apparatus of claim 4, wherein the scheduling DCI is associated with the CORESET pool index.

6. The apparatus of claim 3, wherein the association configuration is received via activating signaling, the activating signaling being DCI or a medium access control (MAC) control element (CE) (MAC-CE) for a semi-persistent sounding reference signal (SP-SRS), a configured grant (CG) physical uplink shared channel (PUSCH), a physical uplink control channel (PUCCH) for semi-persistent channel state information (SP-CSI), or a semi-persistent scheduling (SPS) physical downlink shared channel (PDSCH).

7. The apparatus of claim 3, wherein the association configuration is received via a higher layer configuration, the higher layer configuration being radio resource control (RRC) signaling or a medium access control (MAC) control element (CE) (MAC-CE) for a physical uplink control channel (PUCCH) for persistent channel state information (P-CSI) or persistent scheduling sounding reference signal (P-SRS).

8. The apparatus of claim 2, wherein the association configuration is based on an association between a timing advance group (TAG) and a closed loop index associated with the different sets of UL channels or associated reference signals (RS).

9. The apparatus of claim 8, wherein the association configuration is further based on an association between one or more close loop indexes (CLI) and the first TA or the second TA.

10. The apparatus of claim 2, wherein the association configuration is based on an association between a timing advance group (TAG) and a unified transmission configuration indication (TCI) or a unified TCI group.

11. The apparatus of claim 10, wherein a serving-cell synchronization signal block (SSB) or a first non-serving-cell SSB in a root reference signal (RS) of the unified TCI is associated with the first TA while one or more SSBs of a second non-serving-cell SSB in a non-root RS of the unified TCI are associated with the second TA.

12. The apparatus of claim 1, further comprising at least one transceiver coupled to the at least one processor.

13. An apparatus for wireless communication at a user equipment (UE), comprising:
memory; and
at least one processor coupled to the memory and configured to:
receive, from a network entity, a first timing advance (TA) associated with a first transmission reception point (TRP) associated with the network entity in first downlink control information (DCI);
receive, from the network entity, a second TA associated with a second TRP associated with the network entity in second DCI, the first TA and the second TA being associated with a single component carrier (CC); and
communicate with the network entity based on the first TA and the single CC or based on the second TA and the single CC.

14. The apparatus of claim 13, wherein the at least one processor is configured to communicate with the network entity based on the first TA without being based on the second TA when a first bandwidth part (BWP) in the single CC is related to the first TRP without being related to the second TRP.

15. The apparatus of claim 13, wherein the at least one processor is configured to communicate with the network entity based on a default TA of the first TA or the second TA.

16. The apparatus of claim 15, wherein the default TA is associated with a lower timing advance group (TAG) identifier (ID).

17. The apparatus of claim 13, wherein the at least one processor is configured to communicate with the network entity based on an indication of the first TA or the second TA.

18. The apparatus of claim 13, further comprising at least one transceiver coupled to the at least one processor.

19. An apparatus for wireless communication at a network entity, comprising:
memory; and
at least one processor coupled to the memory and configured to:
transmit, to a user equipment (UE), a first timing advance (TA) associated with a first transmission reception point (TRP) associated with the network entity in first downlink control information (DCI);
transmit, to the UE, a second TA associated with a second TRP associated with the network entity in second DCI, the first TA and the second TA being associated with different sets of uplink (UL) channels based on an association configuration; and
communicate with the UE based on the first TA and the second TA.

20. The apparatus of claim 19, further comprising at least one transceiver coupled to the at least one processor.

21. The apparatus of claim 19, wherein the at least one processor is further configured to:
transmit, to the UE, the association configuration.

22. The apparatus of claim 21, wherein the association configuration is based on an association between a timing advance group (TAG) and a control resource set (CORESET) pool index.

23. The apparatus of claim 22, wherein the association configuration is received via scheduling DCI for a dynamic grant (DG) physical uplink shared channel (PUSCH) or a physical uplink control channel (PUCCH).

24. The apparatus of claim 23, wherein the scheduling DCI is associated with the CORESET pool index.

25. The apparatus of claim 22, wherein the association configuration is received via activating signaling, the activating signaling being DCI or a medium access control (MAC) control element (CE) (MAC-CE) for a semi-persistent sounding reference signal (SP-SRS), a configured grant (CG) physical uplink shared channel (PUSCH), a physical uplink control channel (PUCCH) for semi-persistent channel state information (SP-CSI), or a semi-persistent scheduling (SPS) physical downlink shared channel (PDSCH).

26. The apparatus of claim 22, wherein the association configuration is received via a higher layer configuration, the higher layer configuration being radio resource control (RRC) signaling or a medium access control (MAC) control element (CE) (MAC-CE) for a physical uplink control channel (PUCCH) for persistent channel state information (P-CSI) or persistent scheduling sounding reference signal (P-SRS).

27. The apparatus of claim 21, wherein the association configuration is based on an association between a timing advance group (TAG) and a closed loop index associated with the different sets of UL channels or associated reference signals (RS).

28. The apparatus of claim 27, wherein the association configuration is further based on an association between one or more close loop indexes (CLI) and the first TA or the second TA.

29. An apparatus for wireless communication at a network entity, comprising:
memory; and
at least one processor coupled to the memory and configured to:
transmit, to a user equipment (UE), a first timing advance (TA) associated with a first transmission reception point (TRP) associated with the network entity in first downlink control information (DCI);
transmit, to the UE, a second TA associated with a second TRP associated with the network entity in second DCI, the first TA and the second TA being associated with a single component carrier (CC); and
communicate with the UE based on the first TA and the single CC or based on the second TA and the single CC.

30. The apparatus of claim 29, further comprising at least one transceiver coupled to the at least one processor, wherein the at least one processor is configured to communicate with the UE based on the first TA without being based on the second TA when a first bandwidth part (BWP) in the single CC is related to the first TRP without being related to the second TRP.
